(19) United States
(12) Patent Application Publication
(10) Pub. No.: US 2005/0213266 A1
(43) Pub. Date: Sep. 29, 2005

(54) Horsefeeder

(76) Inventors: Jack Walden Mickelson, Santa Ana, CA (US); James Nelson Kantorik, Santa Ana, CA (US)

Correspondence Address: JACK MICKELSON, UNIT D, 2601 NO. TUSTIN AVE., SANTA ANA, CA, 92705, US

(21) Appl. No.: 10/809,311

(22) Filed: Mar. 26, 2004

(51) Int. Cl. H02H 7/00

(52) U.S. Cl. 361/1

(57) ABSTRACT

A mechanism for automatically dispensing pre-measured quantities of animal feed, in the form of hay, pellets and/or food supplements and medication to livestock at predetermined times of the day. The mechanism consists of an enclosure, with multiple internal shelves, which are hinged at one side and held in a horizontal position by a latching device at the other side. A timing device and logic counting/sequencing circuit controls the operation of the latching solenoids to allow each of the shelves to drop (by gravity) allowing their content to fall through a chute to a feeding trough at the bottom of the enclosure. Power for the operation of the unit can be supplied by a solar cell recharging battery allowing the unit to operate without need for special wiring in remote areas. All food stored within the unit is enclosed and protected from environmental elements and vandal pilferage.

### REFERENCES TO RELATED APPLICATIONS

| | | |
|---|---|---|
| 5,394,832 | March 1995 | Beriley |
| 5,899,169 | May 1999 | Jensen |
| 5,970,912 | October 1999 | Supple et al |
| 6,055,933 | May 2002 | Lyden |
| 6,487,373 | November 2002 | Swetta |
| 6,550,421 | April 2003 | Sturgis |

### STATEMENT REGARDING FEDERAL SPONSORED R & D

No Federal funds were involved in the development of this invention.

### BACKGROUND OF THE INVENTION

People that own animals as pets assume a great responsibility for the care and feeding of these animals. For a horse this usually entails delivery of a slice of hay or some other form of nourishment on a twice a day basis for the life of the animal. People are not always able to maintain this rigorous daily schedule and usually resort to hired help or good friends to fill in for periods of absence. A need was seen for a dispensing device to allow automatic feeding of the animal for a period of 2 to 3 days allowing the owners a free period for relaxation or other duties. In many situations it will probably be used continuously to relieve the twice a day ritual. The device presented here would allow this absence from duty for up to three days. The mechanism must be sturdy and able to withstand the environment of a typical corral, including an occasional kick by the horse, and yet low in cost to produce and easy to maintain.

### BRIEF SUMMARY OF THE INVENTION

The invention is a cabinet with a series of shelves hinged at one side and retained by a latch at the other side. The shelves may be electrically triggered to drop, by gravity, at preset times, The shelves would hold a slice of hay, or other animal food, and/or medicine, up to about 9 inches thick and would be stack arranged to drop to a feeding trough at pre-selectable times. As each shelf dropped it would open space for the shelf above it to be dropped on the next electrical signal from the timing device.

The electronics of the control system is a unique combination of integrated circuits that interact with each other to provide sequencing and duration of the control pulse that controls release of the shelves containing the animal nourishment. The components used in this system are economical and commercially available and have a long history of reliable operation.

### BRIEF DESCRIPTION OF THE DRAWINGS

FIGS. 1-A through 1-D are photographs of the prototype unit installed at a local ranch. The control box, solenoid box and latch handles are best shown on the side of the cabinet in FIGS. 1-A and 1-C. FIG. 1-B shows the door on the loading side of the cabinet. FIG. 1-D shows the feeding trough which extends across the feeding side of the cabinet.

FIG. 2 is a sketch of the shelf layout in the cabinet. The fixed and slanted shelf at the bottom of the cabinet is meant to direct the feed toward the feeding trough, which is not shown in this drawing.

FIG. 3 is a sketch of the latch assembly internal to the cabinet. Two such hinged tabs were used in the prototype to provide stability to the shelf in the raised position. The square part of the cross bar assembly is secured to the round cross member which runs the full width of the cabinet and extends to the handle on the outside of the cabinet. The square tubing need only be long enough to provide attachment area for the hinged tabs near the center of the round cross bar FIG. 4 is a block diagram of the sequential control circuit showing the To/From flow of control pulses between the logic elements.

### DETAILED DESCRIPTION

The construction of the cabinet and its shelves should be fairly evident from the drawings and pictures provided. Vertical stacking of the feed shelves allows the unit to be used where limited ground space is available. The shelves are hinged at the loading side of the cabinet by a round bar extending the full width of the cabinet and affixed to the shelf.

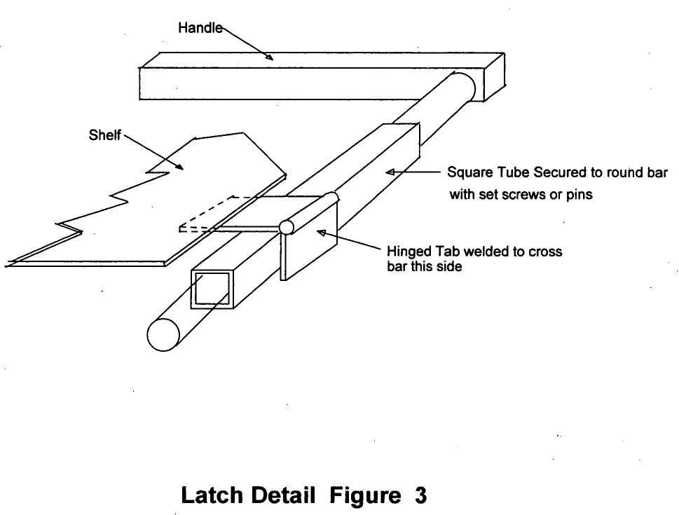

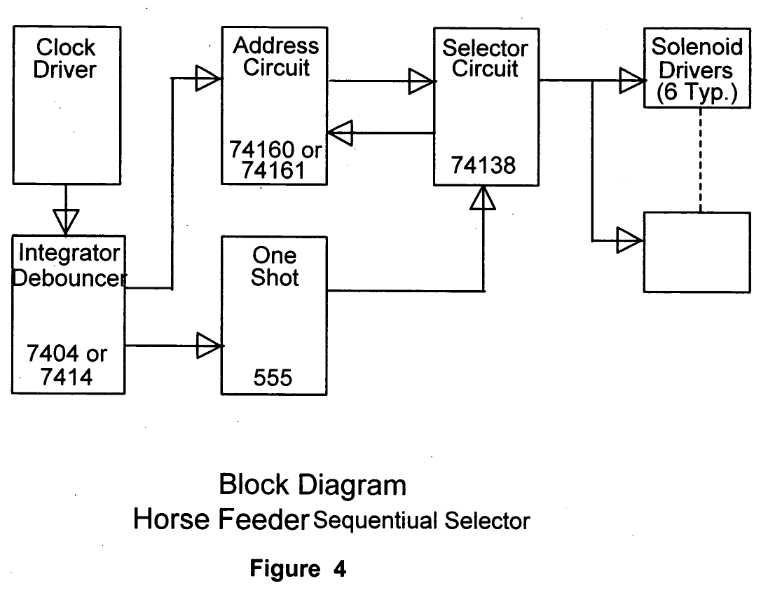

The latch assembly (depicted by FIG. 3) forms the shelf support for the feeding side of the cabinet. The round center bar of the latch assembly extends the full width of the cabinet and is affixed to a handle perpendicular to the bar and extending to the solenoid assembly on one side of the cabinet. The handle has a concentric pin which can be pushed into the solenoid assembly to hold rotation of the handle and cross bar in a fixed position until the solenoid is activated by the timing/counting assembly and pushes the pin from it's latched position

The sequential counting circuit is detailed in the block diagram (FIG. 4). The timing clock is a conventional irrigation type timer; which can be programmed for at least one station and two periods per day. The signal from the timing clock is a TTL type transition from a “0” to a “1” state and interfaced with the TTL circuitry through an optical coupler. An edge detector circuit presents this signal to the 7404 hex inverter, which conditions and cleans the pulse. The pulse is of some finite duration compatible with the requirements of the other ICs in the system. The 7404 then presents the signal to both the 74160 counter IC and to the 74138 BCD decoder IC with appropriate propagation delay to insure proper setting of the 74138 IC when it receives the new BCD count from the 74160 counter. After completion of the count sequence, the 74138 sends a clear signal to the counter IC and count is reduced to zero. Also a reset switch can be pressed at any count to reset the count to zero.

The 555 IC is configured as a monostable mutivibrator (one-shot) presenting a controlled width pulse to the system and to the solenoid driver circuits. The solenoid drivers consist of a 4N33 optical coupler and a power transistor operating in a Darlington configuration.

The latching mechanism (see FIG. 3) is a rotatable round bar extending the width of the feeder. A hollow square tube is affixed to the center portion of this bar. The length of the square tube is sufficient to hold at least one and preferably two of the hinged tabs that support the shelf on the feeding side of the cabinet. Rotation of the cross bar is controlled by a handle, perpendicular to the cross bar, and external to the cabinet. The end of the handle is fitted with a short travel pin which can be inserted into the solenoid assembly to hold the handle in it's raised position. The hinged tabs allow upward rotation such that the shelf may be raised after the latching handle is positioned into the latched position. The handle provides the additional advantage of reducing the tongue weight on the releasing solenoid/latch and consequently on it's size and power consumption.

Power consumption of the mechanism, using “LS” series IC's, in a steady state condition is less than ½ watt. Considerably more power is required during the approximate one half second release stage but the time duration is so short that it can be essentially disregarded in daily energy calculations for solar cell size.

### Drawings: (Total Sheets 4) (Pages 10 to 14)

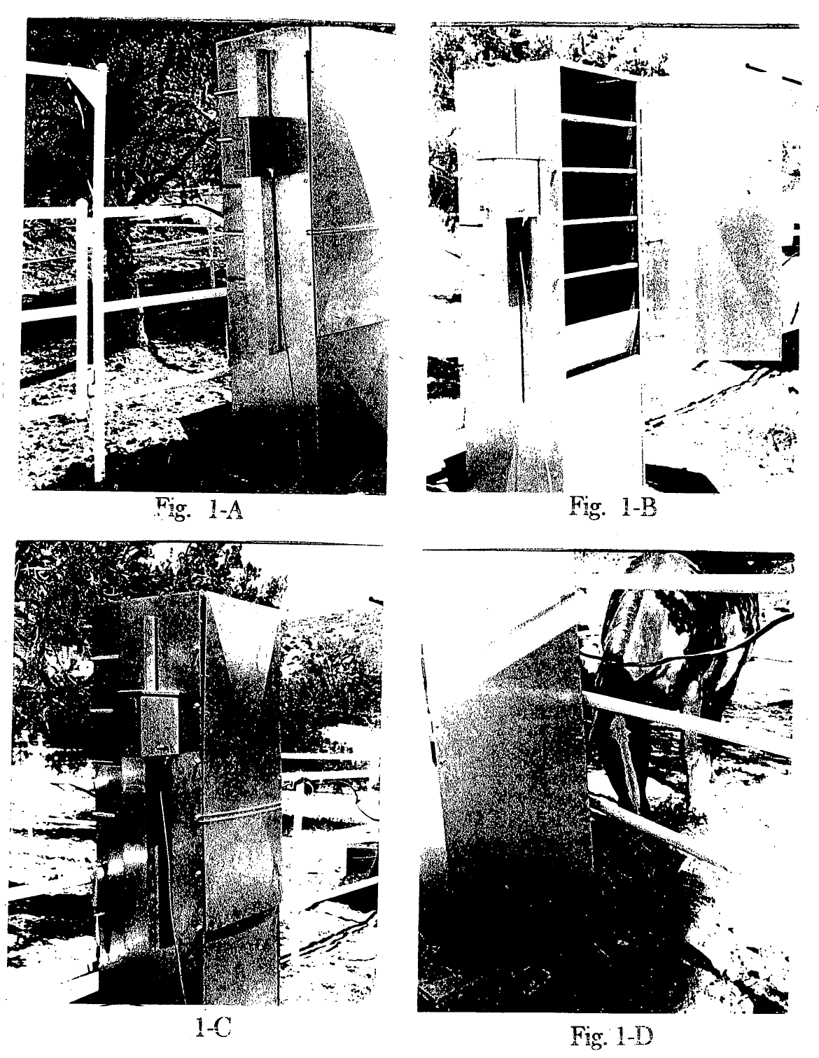

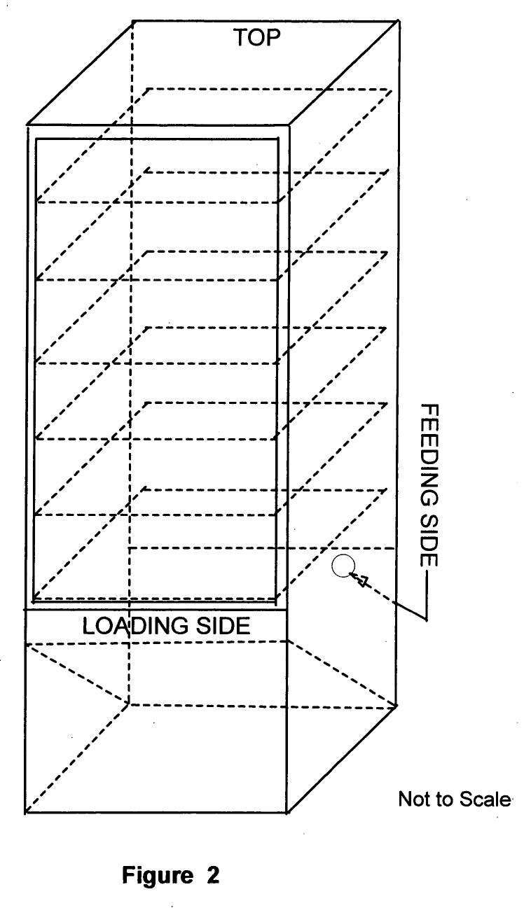

1). Pictures of the original prototype horse feeder. (FIGS. 1-A to 1-D)
2). Pictorial sketch of Horsefeeeder. (FIG. 2)
3). Detailed sketch of latch mechanism. (FIG. 3)
4). Block Diagram of Selector Circuit. (FIG. 4)

1. The sequential selector circuit is a unique combination of inter-connected integrated circuits to convert a change in signal voltage to a pulse of defined duration and apply that pulse to each of several outputs sequentially.

2. The horse feeder cabinet is an improved and cost effective method of delivering nourishment and/or medication for animal consumption that embodies the desirable qualities outlined in the background to the invention

3. The latching system is an improved and energy efficient method of implementing the release of pre-measured quantities of nourishment to the animal.
